(19) United States
(12) Patent Application Publication
(10) Pub. No.: US 2001/0027423 A1
(43) Pub. Date: Oct. 4, 2001

(54) Shopping method

(76) Inventors: Michael Clonts, London (GB); Cathy Clonts, London (GB)

Correspondence Address: Intellectual Property Department, DEWITT ROSS & STEVENS, S.C., Firstar Financial Centre, 8000 Excelsior Driver, Suite 401, Madison, WI, 53717-1914, US

(21) Appl. No.: 09/791,304

(22) Filed: Feb. 23, 2001

(30) Foreign Application Priority Data
Feb. 23, 2000 (GB) 0004315.8

(51) Int. Cl. G06F 17/60

(52) U.S. Cl. 705/26

(57) ABSTRACT

The invention provides a system and method for facilitating on-line shopping. A list of goods or services purchased during a particular customer visit is stored in electronic form and a receipt of that transaction is generated, in electronic or paper form, with the code thereon. For a subsequent purchase, such as on-line, the customer can provide the code, which re-generates the list of goods or services of the previous purchase. The customer can then repeat the same purchase or make quickly and easily amendments to that list. Shopping, particularly on-line, can thus be facilitated.

### FIELD OF THE INVENTION

The present invention relates to a system for and method of facilitating shopping, for example on-line shopping.

### BACKGROUND OF THE INVENTION

Current cash register devices have the capability to store lists of purchases in electronic form (see U.S. Pat. No. 5,189,607 for example). Many retailers offer websites for customers to shop on-line. Shopping on-line may save the customer time and reduce costs for the retailer. Typical on-line shopping requires the shopper to navigate the store website and select items by storing them in an on-line shopping basket for later purchase.

Filling an on-line shopping basket is relatively simple if the customer is purchasing just a few items (for example, books or CDs). When the list of items becomes long, such as with grocery shopping, the process becomes intimidating, tedious and time consuming. Often, a first time user spends more than an hour learning to navigate the website and searching through various web pages to find and load an on-line shopping basket with the items the user purchases regularly. With the numerous steps required of the user, errors are more likely to occur, creating further frustration.

### SUMMARY OF THE INVENTION

The invention involves a shopping system which is intended to at least partially solve the aforementioned problems. To give the reader a basic understanding of some of the advantageous features of the invention, following is a brief summary of preferred versions of the system. As this is merely a summary, it should be understood that more details regarding the preferred versions may be found in the Detailed Description set forth elsewhere in this document. The claims set forth at the end of this document then define the various versions of the invention in which exclusive rights are secured.

According to an aspect of the present invention, there is provided a method of facilitating a purchase of goods or services, comprising the steps of storing information relating to goods or services purchased by a customer, providing to the customer a code representative of said purchase and generating the information on presentation of the code in order to facilitate a subsequent purchase of goods or services.

According to another aspect of the present invention, there is provided a system for facilitating a purchase of goods or services, comprising a store for storing information relating to goods or services purchased by a customer, a code generator for providing a code representative of said purchase, and information regenerating means for generating the information from the store on presentation of the code.

In a preferred embodiment, said information is a list of the goods or services purchased. This list can then be reused or amended for a subsequent purchase. The information is preferably stored in electronic form so as to be accessible via the Internet.

When a user accesses an on-line shopping website, an option will be included to load the basket automatically with all the items purchased during a previous visit to the store. The customer can then immediately purchase the items in the basket or quickly modify the loaded contents. A shopper will be much more inclined to attempt on-line shopping when his/her list of typical purchases is automatically provided on a subsequent on-line visit. This quickly transforms the on-line visit into a simple shopping experience which can take just a few minutes.

In the preferred embodiment, the process begins at the point of sale. An electronic cash register or similar device records each customer's list of items purchased and prints a unique transaction code (hereinafter referred to as a Quick e-Basket code) and the store's web address on the customer's receipt. The list is transferred from the cash register via a network or equivalent method to a database linked to the company's web server. When accessing the store website subsequently, the customer simply enters the Quick e-Basket code from the receipt and the web server automatically fills the on-line shopping basket with all the items on that receipt.

The advantage with the Quick e-Basket process is not only in filling a large basket of groceries. In addition, the quantities of items purchased and the preferred brand are immediately recognised in the saved list of items from the previous shopping. A disadvantage of on-line shopping is that the user does not see the items being purchased. However, if the user is modifying a previous shopping purchase from an earlier store visit, he/she can visualise the items and feel secure about their quantity and quality.

The larger the list the greater is the Quick e-Basket advantage because items can easily be ticked with a yes/no option to purchase or modify quantities.

Further advantages, features, and objects of the invention will be apparent from the following detailed description of the invention in conjunction with the associated drawings.

### BRIEF DESCRIPTION OF THE DRAWINGS

An embodiment of the present invention is described below, by way of example only, with reference to the accompanying drawings, in which:

FIG. 1 shows a flow chart of the preferred embodiment of on-line shopping method;

FIG. 2 shows an example of a receipt produced by the method of FIG. 1.

### DETAILED DESCRIPTION OF PREFERRED EMBODIMENTS OF THE INVENTION

Recording

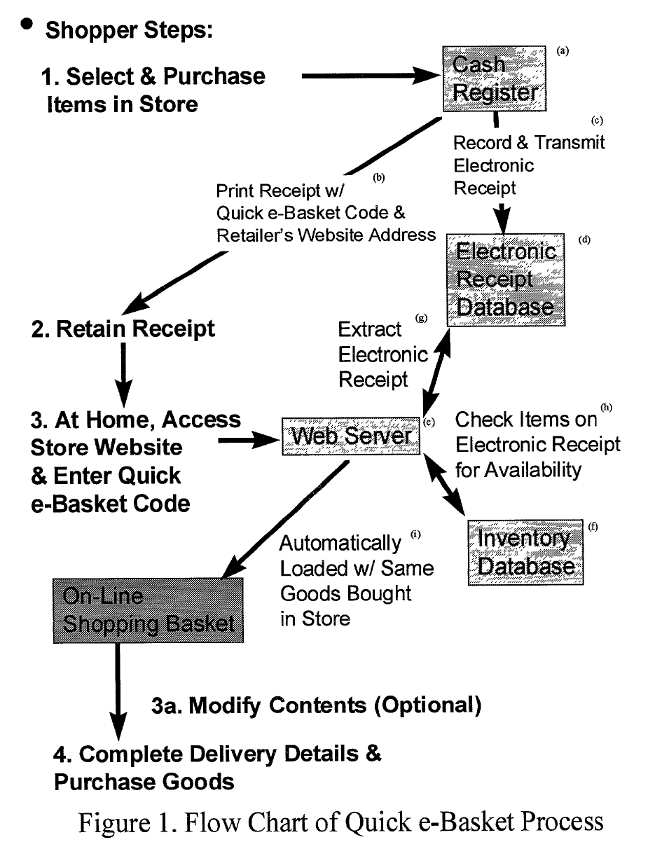

Referring to FIG. 1, the Quick e-Basket process makes use of an electronic cash register(s) or similar device including an interface, a signal sending/receiving unit, a processing unit, a read only memory (referred to as ROM hereinafter), a random access memory (RAM), a key input and a printer. The cash register records all the items purchased for each transaction and stores the information in ROM, along with a unique Quick e-Basket code as described below.

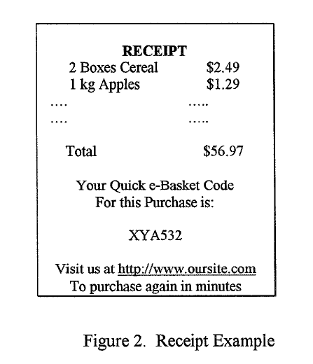

The cash register prints the transaction receipt for the customer, including a unique Quick e-Basket code and the universal record locator (URL) of the retailer's website. FIG. 2 shows an example of such a receipt. The customer retains this receipt to use later when accessing the store's website for more goods.

To maintain uniqueness, the Quick e-Basket code consists of the unique cash register code and the transaction number. In the preferred embodiment, each cash register is assigned a unique three-letter cash register code which is stored in ROM. The first transaction on the cash register has transaction number 1. The ROM is used to keep track of the latest transaction number. For the next transaction number, the RAM reads the latest transaction number and increments it by one in RAM and ROM. For example, the second transaction on cash register XYA would have a unique Quick e-Basket code of XYA2. The receipt shown in FIG. 2 is the 532^{nd} transaction on cash register XYA. The retailer maintains the uniqueness of the Quick e-Basket codes so the customer can later access the correct list of purchases.

Each data record (hereinafter referred to as an electronic receipt) stored on the ROM includes, but is not necessarily limited to, a Quick e-Basket code, a list of items purchased, quantities, units of measure where applicable, time and day of transaction and cash register operator number if available.

Transmittal

The cash register is programmed to transmit automatically the electronic receipts to a host computer at the home office or elsewhere, via a network, FIG. 1(c). Following transmission, the electronic receipts in the ROM are erased. The frequency of transmission is set so as not to exceed the ROM memory capacity with too many electronic receipts. The electronic receipts are transmitted no later than 24 hours following creation.

Storage

When the host computer receives the electronic receipts, they are stored in a database (hereafter called the electronic receipt database), FIG. 1(d). For quick retrieval later, it is preferred that the electronic receipt database resides on the same computer as a web server functioning as the retailer's website providing on-line shopping options for the consumer, FIG. 1(e). If not, the electronic receipt database is linked via a network to the web server. The web server also contains or can query a database of all the items available for on-line purchase (hereinafter referred to as the inventory database), FIG. 1(f).

The electronic receipt database should be backed-up.

Retrieval

When the customer would like to reorder using the web, he/she accesses the retailer's website. The website includes an option for the user to enter the Quick e-Basket code found at the bottom of the receipt, FIG. 1(g). Once this Quick e-Basket code is entered, the web server queries the electronic receipt database and extracts the electronic receipt with the specified Quick e-Basket code. The web server reads the list of purchases on the electronic receipt and queries the inventory database to ensure that those items are available on-line. The items and quantities from the electronic receipt which are available on-line are automatically placed in the on-line shopping basket by the web server, FIG. 1(i). The customer is warned if some of the items previously purchased in-store are not available on-line.

For later calculation of statistics, the web server or the electronic database stores a usage summary file containing a record of all Quick e-Basket codes accessed on-line, marked by the time and day accessed.

Once the on-line shopping basket has been filled using the electronic receipt, the customer is free to continue with the conventional on-line shopping process. The typical process includes options to modify the quantity of items in the shopping basket, remove items, add additional items, specify delivery time and location, provide credit card details and check out.

Statistics

Typically, a reference code is provided for each on-line purchase. A record should be kept of each reference code and its associated Quick e-Basket code. Such information allows the retailer many options for statistical processing. In particular, the file linking the reference codes and Quick e-Basket codes allows the retailer to calculate the on-line revenue associated with the Quick e-Basket process.

During the transmittal step, the electronic receipts may be stored on an intermediate networked computer, perhaps in the store, before transmittal to the host computer.

During the initial in-store purchase, customers concerned about privacy can be reminded that no personal information is stored with the electronic receipt. If still not satisfied, the cash register operator can have the option via the key input device to delete that customer's electronic record.

To avoid an excessively large electronic receipt database, an option can be included for the host computer to delete electronic receipts older than a specified date if a shopper has not accessed them. To limit the size of the database further, a second option can be available to delete electronic receipts older than a specified date even if a shopper has accessed them. Database size can also be reduced with an option to delete any electronic receipts with less than a specified number of items.

The electronic receipt database can reside on the host computer instead of the web server if necessary.

During the retrieval step, the software can be configured to allow the user to log-on to the retailer's website first and then enter the Quick e-Basket code. Similarly, if the electronic receipt contains items that are not available on-line, the web server can provide a list of those items which could not be added to the on-line shopping basket.

When a customer completes an on-line purchasing transaction, another Quick e-Basket code can be provided and the Quick e-Basket process repeated when placing a second order on-line.

Since accessed electronic receipts remain on the electronic receipt database, customers could be rewarded with discounts if they share their Quick e-Basket codes with their friends. Retaining the accessed electronic receipts also allows shoppers to collect different Quick e-Basket codes for different shopping patterns. For example, a shopper may have one Quick e-Basket code for heavy shopping and another Quick e-Basket code for light shopping.

For retailers with more than 17576 cash registers, the three-letter cash register identification can be replaced with a four-letter system.

For shoppers concerned about privacy, the Quick e-Basket process can be modified to include an option to enter a four-digit personal identification number (PIN). The PIN could be appended to the Quick e-Basket code or stored as part of the electronic receipt.

The Quick e-Basket process is probably best suited for multiple item transactions purchased at regular intervals (for example, groceries). The process could also be used by other types of retailers looking to ease the transition of their customers from in-store to on-line. Examples include, but are not limited to, children's clothing with sizes recorded, liquor/beverage stores, pizza and other take-away/delivery shops.

Of course, this system allows also for reordering simply over the telephone with a store worker. A customer need only notify the store worker of the previous transaction code to allow the worker to access the shopping list of that code and to discuss any amendments over the telephone. This can provide a very similar service for customers who are not computer literate or comfortable with the Internet.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings.

What is claimed is:

1. A method of facilitating a purchase of goods or services, comprising the steps of:
a. storing information relating to goods or services purchased by a customer,
b. providing to the customer a code representative of said purchase, and
c. generating the information on presentation of the code in order to facilitate a subsequent purchase of goods or services.

2. A method as in claim 1, wherein said information is a list of goods or services purchased.

3. A method as in claim 2, including the step of allowing reuse or amend the list for a subsequent purchase.

4. A method as in claim 1, wherein said information is stored in electronic form so as to be accessible via the Internet.

5. A method as in claim 2, wherein said information is stored in electronic form so as to be accessible via the Internet.

6. A method as in claim 5, including the step of providing automatic loading of the information or list in an electronic shopping basket on presentation of the code.

7. A method as in claim 1, including the step of providing a personal identification code for identifying a customer.

8. A method as in claim 1, wherein the code is provided on a receipt.

9. A method as in claim 2, wherein the code is provided on a receipt.

10. A system for facilitating a purchase of goods or services, comprising
a. a store for storing information relating to goods or services purchased by a customer,
b. a code generator for providing a code representative of said purchase, and
c. information regenerating means for generating from the store the information on presentation of the code.

11. A system as in claim 10, wherein said information is a list of goods or services purchased.

12. A system as in claim 10, wherein the information generating means provides for amendment of the information for a subsequent purchase.

13. A system as in claim 11, wherein the information generating means provides for amendment of the list for a subsequent purchase.

14. A system as in claim 10, wherein said information store includes a computer memory wherein said information is stored in electronic form.

15. A system as in claim 11, wherein said information store includes a computer memory wherein said list is stored in electronic form.

16. A system as in claim 10, including a user interface, the generating means being operable to load the information in an electronic shopping basket on the user interface presentation of the code.

17. A system as in claim 11, including a user interface, the generating means being operable to load the list in an electronic shopping basket on the user interface presentation of the code.

18. A system as in claim 10, including communication means for allowing remote access to the system by a user.

19. A system as in claim 18, wherein the communication means includes the Internet.

20. A system as in claim 11, including communication means for allowing remote access to the system by a user.

21. A system as in claim 20, wherein the communication means includes the Internet.

22. A system as in claim 10, including printing means operable to print a receipt with the code thereon.

23. A system according to claim 22, wherein the printing means is operable to print an electronic or paper receipt.
